(19) United States
(12) Patent Application Publication
(10) Pub. No.: US 2013/0273432 A1
(43) Pub. Date: Oct. 17, 2013

(54) GRAPHITE MATERIAL FOR A LITHIUM ION SECONDARY CELL NEGATIVE ELECTRODE, METHOD OF MANUFACTURING SAME, AND LITHIUM ION SECONDARY CELL

(71) Applicant: JX NIPPON OIL & ENERGY CORPORATION, Yokohama-shi (JP)

(72) Inventors: Noriyo ISHIMARU, Minato-ku (JP); Takashi SUZUKI, Yokohama-shi (JP); Takefumi KONO, Setagaya-ku (JP)

(21) Appl. No.: 13/915,784

(22) Filed: Jun. 12, 2013

Related U.S. Application Data
(63) Continuation of application No. PCT/JP2011/078078, filed on Dec. 5, 2011.

(30) Foreign Application Priority Data
Dec. 13, 2011 (JP) 2010-277230

(51) Int. Cl. H01M 4/133

(52) U.S. Cl. CPC H01M 4/133
USPC 429/231.8; 423/448

(57) ABSTRACT

A graphite material for a negative electrode of a lithium ion secondary cell is capable of suppressing capacity degradation caused by the repetition of charging and discharging cycles, storage in a charged state, floating charging and the like. A graphite material for a negative electrode of a lithium ion secondary cell, in which Lc (112), which is a crystallite size in a c-axis direction calculated from a (112) diffraction line measured using powder X-ray diffraction method, is within 4.0 nm to 30 nm, a carbon-derived spectrum appearing in electron spin resonance spectroscopy, which is measured using an X band, is in a range of 3200 gauss (G) to 3400 gauss (G), a relative signal intensity ratio (I_{4.8K}/I_{40K}) of the signal intensity (I_{4.8K}) of the spectrum measured at a temperature of 4.8 K to the signal intensity (I_{40K}) of the spectrum measured at a temperature of 40 K is within 1.5 to 3.0, and ΔHpp, which is a line width of the spectrum calculated from a primary derivative spectrum of the temperature of 4.8 K, is within 20 gauss (G) to 40 gauss (G).

This application is a continuation of PCT/JP2011/078078, filed on Dec. 5, 2011.

### BACKGROUND OF THE INVENTION

1. Field of the Invention

The present invention relates to a graphite material used for a negative electrode of a lithium ion secondary cell. More particularly, the invention relates to a graphite material used for a negative electrode of a lithium ion secondary cell with high durability and with suppressed capacity degradation, a method of manufacturing the same, and a lithium ion secondary cell including a negative electrode formed of the graphite material.

2. Description of Related Art

Since a lithium ion secondary cell has a low weight and excellent input and output characteristics in comparison with a nickel-cadmium cell, a nickel-hydrogen cell and a lead cell, which are secondary cells in the related art, the lithium ion secondary cell is recently being anticipated as a power source for electric cars or hybrid cars. In general, such a type of cell has a structure in which a positive electrode (cathode) including lithium which can be reversibly intercalated and a negative electrode (anode) formed of a carbon material face each other with a non-aqueous electrolyte interposed therebetween. Therefore, these cells do not enter a dischargeable state when they are not assembled in a discharged state and then charged. Hereinafter, charging and discharging reactions will be described with reference to an example in which a positive electrode including lithium cobalt oxide (LiCoO₂), a negative electrode including a carbon material, and a non-aqueous electrolyte solution including a lithium salt as an electrolyte are used.

First, when a first charging cycle is performed, lithium included in the positive electrode is emitted to the electrolyte (the following Formula 2), and the positive electrode potential goes in the higher direction. In the negative electrode, the lithium emitted from the positive electrode is occluded in the carbon material (the following Formula 3), and the negative electrode potential goes in the lower direction. In general, when the difference between the positive electrode potential and the negative electrode potential, that is, the cell voltage, reaches a predetermined value, the charging reaction is cut off. This value is called charging cutoff voltage. In the discharging reaction, lithium occluded in the negative electrode is emitted, the negative electrode potential goes in the higher direction, lithium is occluded in the positive electrode again, and the positive electrode potential goes in the lower direction. Similarly to the charging reaction, when the difference between the positive electrode potential and the negative electrode potential, that is, the cell voltage, reaches a predetermined value, the discharging reaction is cut off. This value is called discharging cutoff voltage. The total charging and discharging reaction formula is expressed by the following Formula 4. In the second cycle or the subsequent cycles thereto, lithium comes and goes between the positive electrode and the negative electrode to progress the charging and discharging reaction (cycle).

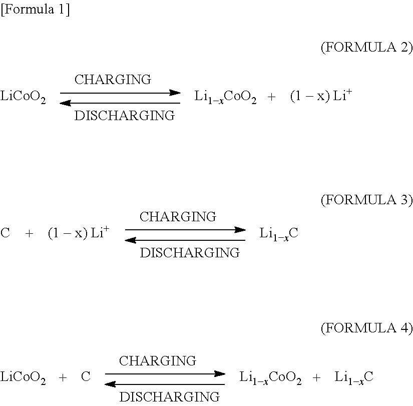

The carbon material used as the material for a negative electrode of a lithium ion secondary cell is generally approximately classified as a graphite-based material and an amorphous carbon material. The graphite-based carbon material has an advantage that the energy density per unit volume is higher than the amorphous carbon material. Therefore, the graphite-based carbon material is generally used as the material of a negative electrode in a lithium ion secondary cell for mobile phones or notebook calculaters requiring a compact structure and a large charging and discharging capacity. Graphite has a structure in which reticulated planes of carbon atoms are regularly laminated, and intercalation and deintercalation reactions of lithium ions proceeds in an edge portion of crystallites during charging and discharging.

As described above, such a type of cell is actively studied as a power storage device for vehicles, industry, and power supply infrastructure. When the cells are used for these applications, very high reliability is required, compared to a case in which they are used for mobile phones or notebook calculaters. Here, reliability is a characteristic associated with the service life and can be said to be a storage characteristic. That is, reliability means a characteristic that charging and discharging capacity or internal resistance are not changed much (not degraded much) even when the charging and discharging cycles are repeated, even when the cell is stored in a charged state with a predetermined voltage, or even when the cell continues to be charged with a constant voltage (when floating-charged).

On the other hand, it is generally known that the service life characteristics of lithium ion secondary cells having been used for mobile phones or notebook calculaters in the past greatly depends on the material of the negative electrode. This is because it is not possible in principle to set the charging and discharging efficiencies of the positive electrode reaction (Formula 2) and the negative electrode reaction (Formula 3) to be completely equal to each other and the charging and discharging efficiency of the negative electrode is lower. Here, the charging and discharging efficiency means the ratio of dischargeable electric capacity to the electric capacity consumed in charging. Hereinafter, the reaction mechanism in which the service life characteristic degrades due to the lower charging and discharging efficiency of the negative electrode reaction will be described in detail.

In the process of charging, as described above, lithium in the positive electrode is emitted (Formula 2) and occluded in the negative electrode (Formula 3), but the electric capacity consumed in the charging is the same in the positive electrode reaction and the negative electrode reaction. However, since the charging and discharging efficiency is lower in the negative electrode, the discharging may be cut off in a state in which the amount of lithium emitted from the negative electrode is smaller than the amount of lithium which can be occluded in the positive electrode, that is, the amount of lithium occluded in the positive electrode before the charging, in the subsequent discharging reaction. This is because a part of the electric capacity consumed in the charging in the negative electrode is consumed in side reactions and competitive reactions but is not consumed in the reaction in which lithium is occluded, that is, the reaction in which lithium is occluded as the dischargeable capacity.

Since such charging and discharging reactions occur, the positive electrode potential in the discharging cutoff state goes to a side higher than the original potential before the charging and discharging reactions, and the negative electrode potential also goes to a side higher than the original potential before the charging and discharging reactions. This is because all lithium emitted in the charging process of the positive electrode is not occluded (is not returned) during the discharging, the potential has gone in the higher direction in the charging process cannot be returned to the original positive electrode potential by the amount corresponding to the difference in the charging and discharging efficiency between the positive electrode and the negative electrode even when it goes in the lower direction in the discharging process, and thus discharging is cut off at a potential higher than the original positive electrode potential. As described above, the discharging of a lithium ion secondary cell is completed when the cell voltage (that is, the difference between the positive electrode potential and the negative electrode potential) reaches a predetermined value (the discharging cutoff voltage). Accordingly, when the potential of the positive electrode at the time point of cutting off the discharging becomes higher, the potential of the negative electrode also goes in the higher direction by the same amount.

As described above, when such a type of cell repeats the charging and discharging cycles, there is a problem in that the capacity obtained within a predetermined voltage range (within the range of the discharging cutoff voltage and the charging cutoff voltage) decreased due to the change in operational range of the capacity of the positive and negative electrodes. The reaction mechanism of such a capacity degradation has been reported in academic societies (Summary 1A11 of the 48^{th} Battery Symposium in Japan (Nov. 13, 2007 and Summary 1P29 of the 76^{th} Annual Meeting of the Electrochemical Society of Japan (Mar. 26, 2009)).

### SUMMARY OF THE INVENTION

Meanwhile, the reason for the low charging and discharging efficiency of the negative electrode is that some of the electric capacity consumed in charging in the negative electrode is consumed in a side reaction and a competitive reaction, and thus is not consumed in a reaction in which lithium is occluded as described above, and the side reaction and the competitive reaction are caused mainly by a decomposition reaction of the electrolyte solution on the edge surface of a reticulated plane laminate exposed to the particle surface of the graphite material.

In general, on the edge surface of the reticulated plane laminate, a number of dangling bonds, that is, a number of localized electrons of which valence electron bonds are not saturated and which are present without bonding opponents, are present. It is considered that, in the charging process, on the surface of the graphite material in the negative electrode, that is, on the interface on which the electrolyte solution and the graphite material come into contact with each other, not only the intended charging reaction, in which lithium is intercalated between reticulated plane layers, but also the side reaction and the competitive reaction, which are caused by the catalytic action of the localized electrons and the reduction and decomposition of the electrolyte solution, are caused such that the charging and discharging efficiency of the negative electrode decreases.

In addition, in a case in which the side reaction and the competitive reaction are caused in the negative electrode, the reaction product is a solid that is insoluble in the electrolyte solution at room temperature. Therefore, as the charging and discharging cycle proceeds, the surface of the graphite material in the negative electrode is applied with the reaction product, and the film grows (accumulates) thickly. This film becomes a low-resistance component in a reversible intercalation reaction of Li ions, and therefore the growth of the film causes an increase in the internal resistance as a cell. Particularly, since the film is easily formed and grown on the edge surface of the reticulated plane laminate on the surface of the graphite material, which serves as the entrance and exit of Li ions, there was a problem in that, as the charging and discharging cycle proceeds, the internal resistance of the cell increases, and the apparent cell capacity obtained at a predetermined current also decreases as the cycle proceeds.

As described above, the capacity degradation of a lithium ion secondary cell due to the repetition of the charging and discharging cycle was caused by the following two facts: (1) the change in the operational ranges of the positive and negative electrode capacities due to the side reaction and the competitive reaction in the negative electrode, and (2) the continuous increase in the internal resistance of the cell following the above change. Therefore, for the graphite material in the negative electrode, there was a demand for a function that suppresses the side reaction and the competitive reaction in the negative electrode, and suppresses the growth of the film following the proceeding of the charging and discharging cycle.

An object of the invention is to solve the above capacity degradation caused by the repetition of the charging and discharging cycle of a lithium ion secondary cell, and means for the object is to develop a graphite material for the negative electrode of a lithium ion secondary cell, which can suppress the capacity degradation of the charging and discharging cycle, thereby providing a material for a negative electrode of a lithium secondary cell for vehicles, industry and electric storage infrastructure, which requires a high degree of reliability.

### Means for Solving the Problems

In order to solve the above problem, according to a first aspect of the invention, there is provided a graphite material for a negative electrode of a lithium ion secondary cell, in which Lc (112), which is a crystallite size in a c-axis direction calculated from a (112) diffraction line measured using powder X-ray diffraction method, is within 4.0 nm to 30 nm, a carbon-derived spectrum appearing in electron spin resonance spectroscopy, which is measured using an X band, is in a range of 3200 gauss (G) to 3400 gauss (G), a relative signal intensity ratio I_{4.8K}/I_{40K} of I_{4.8K}, which is a signal intensity of the spectrum measured at a temperature of 4.8 K, to I_{40K}, which is a signal intensity of the spectrum measured at a temperature of 40 K, is within 1.5 to 3.0, and ΔHpp, which is a line width of the spectrum calculated from a primary derivative spectrum of the temperature of 4.8 K, is within 20 gauss (G) to 40 gauss (G).

In order to solve the above problem, according to a second aspect of the invention, there is provided a method of manufacturing the graphite material for a negative electrode of a lithium ion secondary cell according to the first aspect, including at least a step of coking a base oil composition having a normal paraffin content of 5.0 wt % to 20 wt % and an aromatic index fa, which is obtained using a Knight method, of 0.3 to 0.65 using a direct coking process, and a step of a thermal process after the coking.

In order to solve the above problem, according to a third aspect of the invention, there is provided a lithium ion secondary cell including a negative electrode, for which the graphite material according to the first aspect is used.

In order to solve the above problem, according to a fourth aspect of the invention, there is provided the lithium ion secondary cell according to the third aspect further including a positive electrode including lithium which can be reversibly intercalated; and a non-aqueous electrolyte.

### Advantageous Effect of the Invention

A lithium ion secondary cell, for which the graphite material of the invention is used as a negative electrode material, enables the securement of a high reliability characteristic compared to a lithium ion secondary cell, in which a graphite material of the related art is used, and is thus available for industrial use, such as vehicles, specifically, hybrid cars, plug-in hybrid cars and electrical cars; or power storage of a system infrastructures.

### BRIEF DESCRIPTION OF THE DRAWING

FIG. 1 is a cross-sectional view of a cell.

### DESCRIPTION OF THE PREFERRED EMBODIMENTS

Hereinafter, the invention will be described in detail.

In a graphite material having the properties described in the first aspect according to the invention, a side reaction and a competitive reaction are suppressed in a negative electrode, and the growth of a film following the proceeding of a charging and discharging cycle is suppressed.

First, the side reaction and the competitive reaction in the negative electrode are mainly a decomposition reaction of an electrolyte solution as described above. The decomposition reaction of the electrolyte solution proceeds using localized electrons present on the edge surface of a reticulated plane laminate exposed to the particle surface of the negative electrode as a catalyst, and therefore, in order to suppress the decomposition reaction of the electrolyte solution, the edge surface exposed on the surface is preferably small.

In addition, the growth of a film following the proceeding of the charging and discharging cycle is likely to intensively occur at places in which the state of the edge surface exposed to the particle surface of the negative electrode is well-defined. Therefore, on the edge surface having a well-defined state, an extremely thick film is locally formed. In a case in which the above graphite material is used as the negative electrode, since a resistance component of the reversible intercalation reaction of Li ions in the negative electrode increases, an internal resistance of the cell increases, which is not desirable. Therefore, in order to thin a film formed of a reaction product, a state in which the decomposition reaction of the electrolyte solution is caused dispersedly is preferable, and in order to achieve the above state, it is preferable to have a plurality of states of the edge surface exposed to the particle surface.

That is, the first aspect according to the invention regulates a graphite material, in which the edge surface exposed to the particle surface is small, and a plurality of states of the edge surface is present, and when this graphite material is used as the negative electrode of a lithium ion secondary cell, it is possible to provide the lithium ion secondary cell having excellent service life characteristics.

In the graphite material regulated in the first aspect according to the invention, Lc (112), which is a crystallite size in a c-axis direction calculated from a (112) diffraction line of the graphite material measured using powder X-ray diffraction method, is within 4.0 nm to 30 nm, a carbon-derived spectrum appearing in electron spin resonance spectroscopy, which is measured using an X band, is in a range of 3200 gauss (G) to 3400 gauss (G), a relative signal intensity ratio I_{4.8K}/I_{40K} of I_{4.8K}, which is a signal intensity of the spectrum measured at a temperature of 4.8 K, to I_{40K}, which is a signal intensity of the spectrum measured at a temperature of 40 K, is within 1.5 to 3.0, and ΔHpp, which is a line width of the spectrum calculated from a primary derivative spectrum of the temperature of 4.8 K, is within 20 gauss (G) to 40 gauss (G).

It can be said that the above graphite material is a graphite material having a small edge surface exposed to the particle surface and a plurality of states of the edge surface. In a lithium ion secondary cell, for which the above graphite material is used, since the decomposition reaction of the electrolyte solution in the negative electrode is suppressed, a difference in the operational ranges between the positive electrode and the negative electrode is not easily caused, and the formation of a film on the edge surface is also suppressed, whereby the resistance component of the reversible intercalation reaction of Li ions does not easily increase either. In the above lithium ion secondary cell, it becomes possible to secure a high degree of storage characteristic.

In the graphite material, the relative amount and the number of states of the edge surface exposed to the particle surface can be understood using I_{4.8L}/I_{40K}, which is the relative signal intensity ratio obtained from the electron spin resonance (hereinafter sometimes referred to as ESR) spectrum of the graphite material, and the line width ΔHpp.

First, when ESR is measured at a temperature of 40 K, the amount of the edge surface exposed to the particle surface can be relatively understood from the degree of I_{4.8K}/I_{40K}, which is the relative signal intensity ratio of I_{4.8K}, which is the signal intensity at a temperature of 4.8 K, to I_{40K}, which is the signal intensity of a carbon-derived spectrum appearing in a range of 3200 gauss (G) to 3400 gauss (G), and the number of surfaces present in a state of the edge surface, that is, the number of the edge surfaces can be relatively understood from the degree of ΔHpp, which is a line width of an ESR spectrum at the temperature of 4.8 K.

Therefore, the ranges of I_{4.8K}/I_{40K}, which is the signal intensity ratio of ESR spectra, and ΔHpp, which is a line width, which are regulated in the first aspect, can be said to specifically regulate the ranges of the properties of a graphite material having a small edge surface exposed to the particle surface and a plurality of states of the edge surface.

Here, ESR measurement will be described.

ESR measurement is a spectrometry that observes the transition of unpaired electrons between levels in a magnetic field. When a magnetic field is applied to a substance having unpaired electrons, the energy level of the substance is divided into two levels due to the Zeeman Effect. The measurement is observed by sweeping a magnetic field under the radiation of microwaves, and ΔE, which is a division spacing of energy, increases as the applied magnetic field increases. Resonant absorption is observed when ΔE becomes equal to the energy of the radiated microwave, and an ESR spectrum is obtained by detecting the amount of absorbed energy at this time.

The ESR spectrum is, in general, obtained using the primary derivative spectrum, and the primary derivative spectrum becomes an absorption spectrum when integrated once, and becomes the signal intensity when integrated twice. The size of the signal intensity at this time becomes an index that indicates the size of the density of unpaired electrons in the substance.

In a carbon material, there are two kinds of unpaired electrons—localized electrons and conduction electrons. That is, in the ESR measurement of the carbon material, the sum of the resonant absorptions of microwaves caused by the above two kinds of unpaired electrons is observed as an ESR spectrum. The signal intensity obtained by integrating the obtained ESR spectrum twice becomes an index that indicates the size of the unpaired electron density which is the sum of the conduction electron density and the localized electron density.

Here, the conduction electrons in the carbon material refer to unpaired π electrons which voluntarily develop in association with the number and bonding form of a ring that forms the reticulated plane, and can freely move in the reticulated plane (refer to Carbon 1966 No. 47 30 to 34 and Carbon 1967 No. 50 20 to 25). Meanwhile, the localized electrons refer to localized electrons present on the edge surface of a reticulated plane laminate, and are immobile electrons.

In addition, while the signal intensity of the resonant absorption through the conduction electrons does not rely on temperature, the signal intensity of the resonant absorption through the localized electrons increases in inverse proportion to T, which is a measured temperature. For example, it is reported that, in the ESR measurement of the carbon material in a temperature range of 4.2 K≦T≦300 K, in a case in which ESR is measured while the measurement temperature gradually decreases from 300 K, the absorption of microwaves through the localized electrons begins to be observed at approximately 50 K, and at a low temperature range of 50 K or lower, the signal intensity through the localized electrons increases in inverse proportion to T, which is the measurement temperature (refer to Carbon 1996 No. 175 249 to 256).

From the above facts, it can be said that, in a low-temperature range of 50 K or lower, I_{4.8K}/I_{40K}, which is the ratio of the signal intensities of the ESR spectra obtained at two temperatures, that is, 4.8 K and 40 K, is an index that relatively indicates the size of the localized electron density. In addition, in the invention, the relative size of the localized electron density estimated from I_{4.8K}/I_{40K}, which is the ratio of the signal intensities, was considered as an index that indicates the relative amount of the edge surface exposed to the particle surface.

Meanwhile, ΔHpp, which is a line width, is a spacing between two peaks made up of the maximum peak and the minimum peak in the ESR spectrum, that is, the primary derivative spectrum, and an index that indicates the state of unpaired electrons. In unpaired electrons having different states, since the sizes of ΔE, which is an energy spacing caused by a magnetic field, are different, resonant absorption occurs at different magnetic fields. Meanwhile, the ESR spectrum of the graphite material is a spectrum obtained by averaging different absorption spectra of the resonant magnetic field. Therefore, in a case in which there is a plurality of unpaired electrons having different states, that is, a plurality of resonant absorptions occurs in different magnetic fields, the ESR spectrum becomes, apparently, a broad spectrum, and ΔHpp, which is a line width, increases.

In particular, it is considered that, in a low-temperature range, in which the contribution of the localized electrons is large, in a case in which ΔHpp is large, there is a plurality of states of the localized electrons in the graphite material. The fact that there is a plurality of states of the localized electrons can be said in a different manner that, that is, there is a plurality of states of the edge surface on which the localized electrons are present.

From the above facts, in the low-temperature range of 50 K or lower, ΔHpp can be said to be an index that indicates a large number of states of the edge surface exposed to the particle surface of the graphite material.

In the first aspect according to the invention, it is controlled so that, when ESR is measured at a temperature of 40 K, I_{4.8K}/I_{40K}, which is the relative signal intensity ratio of I_{4.8K}, which is the signal intensity of a spectrum at a temperature of 4.8 K, to I_{40K}, which is the signal intensity of a carbon-derived spectrum appearing in a range of 3200 gauss (G) to 3400 gauss (G), is within 1.5 to 3.0.

As described above, the low-temperature range of a measurement temperature of 50 K or lower is a temperature range in which the contribution of the localized electrons increases, and in this area, the signal intensity through the localized electrons increases in inverse proportion to the measurement temperature. It can be said from the above fact that, in the low-temperature range of a temperature of 50 K or lower, the localized electron density increases as a change in the signal intensity with respect to the measurement temperature increases.

In the invention, the signal intensity ratio at two measurement temperatures of 4.8 K and 40 K was used as an index that indicates the size of the localized electron density, that is, an index that indicates the relative amount of the edge surface exposed to the particle surface. The reason for selecting two temperatures of 4.8 K and 40 K is that, since the measurement temperature of 40 K is a temperature at which the contribution of the localized electrons begins, and meanwhile, the contribution of the localized electrons becomes sufficiently large at a measurement temperature of 4.8 K, it is considered that the signal intensity ratios at the above two temperatures indicate the most accurate signal intensity ratio in the temperature range of 50 K or lower.

When measured at a temperature of 40 K obtained through the ESR measurement of the graphite material, in a case in which I_{4.8K}/I_{40K}, which is the relative signal intensity ratio of I_{4.8K}, which is the signal intensity of a spectrum at a temperature of 4.8 K, to I_{40K}, which is the signal intensity of a carbon-derived spectrum appearing in a range of 3200 gauss (G) to 3400 gauss (G), is less than 1.5, it can be said that the localized electron density is extremely small. Such a graphite material is in a state in which the edge surface exposed to the particle surface is small. In a lithium ion secondary cell, for which the graphite material is used as the negative electrode, the decomposition reaction of the electrolyte solution is easily caused, and a reaction product is locally accumulated so as to form a thick film intensively on the small edge surface. Therefore, since the resistance component of the reversible intercalation reaction of Li ions increases, the internal resistance of the cell increases, and the service life characteristic degrades, which is not desirable.

When measured at a temperature of 40 K obtained through the ESR measurement of the graphite material, in a case in which I_{4.8K}/I_{40K}, which is the relative signal intensity ratio of I_{4.8K}, which is the signal intensity of a spectrum at a temperature of 4.8 K, to I_{40K}, which is the signal intensity of a carbon-derived spectrum appearing in a range of 3200 gauss (G) to 3400 gauss (G), exceeds 3.0, it can be said that the localized electron density is extremely large. Such a graphite material is in a state in which the edge surface exposed to the particle surface is large. Therefore, in a lithium ion secondary cell, for which this graphite material is used as the negative electrode, the decomposition reaction of the electrolyte solution using the localized electrons as a catalyst in the negative electrode is easily caused. In this case, since the difference between the leak current of the negative electrode and the leak current of the positive electrode increases, the operational ranges of the capacities of the positive and negative electrodes change, and the service life characteristic degrades, which is not desirable.

As described above, when measured at a temperature of 40 K obtained through the ESR measurement of the graphite material, in a case in which I_{4.8K}/I_{40K}, which is the relative signal intensity ratio of I_{4.8K}, which is the signal intensity of a spectrum at a temperature of 4.8 K, to I_{40K}, which is a signal intensity of a carbon-derived spectrum appearing in a range of 3200 gauss (G) to 3400 gauss (G), is limited to 1.5 to 3.0. A graphite material having properties in the above range has an amount of the edge surface of the reticulated plane laminate exposed to the particle surface in an appropriate range.

In the first aspect according to the invention, it is also controlled so that the ESR spectrum at a measurement temperature of 40 K, which is obtained through the ESR measurement of the graphite material, that is, ΔHpp, which is a line width between the peaks of a primary derivative spectrum, is within 20 gauss (G) to 40 gauss (G).

ΔHpp, which is a line width of the ESR spectrum at a measurement temperature of 40 K, is an index that indicates a large number of states of the localized electrons. Since a large ΔHpp indicates the presence of a plurality of states of the localized electrons, that is, there is a plurality of states of the edge surface. On the other hand, since a small ΔHpp indicates the small number of states of the localized electrons, that is, the number of the states of the edge surface is small.

In a case in which ΔHpp, which is a line width of the ESR spectrum at a measurement temperature of 40 K, which is obtained from the ESR measurement of the graphite material, that is, between the peaks of a primary derivative spectrum is less 20 G, it is indicated that the number of states of the localized electrons on the surface of the graphite material is small, and the edge surface having a well-defined state is exposed to the particle surface. In a lithium ion secondary cell, for which the above graphite material is used as the negative electrode, since the state of the edge surface exposed to the particle surface of the negative electrode is well-defined, the decomposition reaction of the electrolyte solution is intensively caused, and a thin film is locally formed on the edge surface. Therefore, the resistance component of the reversible intercalation reaction of Li ions increases, and the internal resistance of the cell increases, and therefore, the service life characteristic degrades, which is not desirable.

In a case in which ΔHpp, which is a line width of the ESR spectrum at a measurement temperature of 40 K, which is obtained from the ESR measurement of the graphite material, that is, between the peaks of a primary derivative spectrum exceeds 40 G, it is indicated that the number of states of the localized electrons present on the surface of the graphite material extremely increases. In this case, it can be said that the crystal structure around the reticulated plane laminate is significantly disordered. In a lithium ion secondary cell, for which the above graphite material is used as the negative electrode, since the reversible intercalation reaction of Li ions in the negative electrode is stereoscopically inhibited due to the significant disorder of the crystal structure, the resistance component of the reversible intercalation reaction of Li ions increases. In this case, the internal resistance of the cell increases, and the service life characteristic degrades, which is not desirable.

As described above, ΔHpp, which is a line width of the ESR spectrum at a measurement temperature of 40 K obtained from the ESR measurement of the graphite material, that is, between the peaks of a primary derivative spectrum, is limited to 20 gauss (G) to 40 gauss (G). A graphite material having properties in the above range can be said to be in a state in which a plurality of states of the localized electrons on the edge surface exposed to the particle surface is appropriately present.

As such, in a graphite material, in which I_{4.8K}/I_{40K}, which is the relative signal intensity ratio of I_{4.8K}, which is the signal intensity of the spectrum measured at a temperature of 4.8 K, to I_{40K}, which is the signal intensity of the ESR spectrum measured at a temperature of 40 K obtained from the ESR measurement, is within 1.5 to 3.0, and ΔHpp, which is a line width of the spectrum calculated from a primary derivative spectrum of a temperature of 4.8 K, is within 20 gauss (G) to 40 gauss (G), the edge surface exposed to the particle surface is small, and a plurality of states of the edge surface is present. In a lithium ion secondary cell, for which the graphite material is used, since the decomposition reaction of the electrolyte solution using the localized electrons in the negative electrode as a catalyst is not easily caused, the operational ranges of the capacities of the positive and negative electrodes do not change, and, additionally, the internal resistance of the cell does not increases as the charging and discharging cycle proceeds, it is possible to secure an extremely high reliability.

Meanwhile, the reason for regulating in the first aspect according to the invention that Lc (112), which is the crystallite size calculated from a (112) diffraction line obtained using the X-ray wide-angle diffraction of the graphite material, becomes within a range of 4.0 nm to 30 nm will be described.

First, in a graphite material having an Lc(112) of less than 4 nm, the crystal structure does not develop sufficiently, and in a lithium ion secondary cell, for which the graphite material is used, the capacity is small, which is not desirable. In addition, the reason for setting the upper limit to 30 nm is that it is extremely difficult to obtain a graphite material having a size of greater than 30 nm, and that large graphite material is not realistic.

A second aspect according to the invention regulates a specific manufacturing method of obtaining the graphite material regulated in the first aspect. That is, the second aspect according to the invention is a method of manufacturing a graphite material for a negative electrode of a lithium ion secondary cell including at least a step of coking a base oil composition having a normal paraffin content of 5.0 wt % to 20 wt % and an aromatic index fa, which is obtained using a Knight method, of 0.3 to 0.65 using a delayed coking process, and a step of a subsequent thermal process.

As a process for manufacturing a graphite material for a negative electrode of a lithium ion secondary cell, a method, “in which a base oil composition is coked using a delayed coking process, and then thermally treated” is generally known. The present inventors and the like found that it is possible to manufacture a graphite material regulated in the first aspect according to the invention using the above process by limiting the properties and composition of a base oil composition and the coking conditions.

In the graphite material regulated in the first aspect according to the invention, the edge surface of the reticulated plane laminate exposed to the particle surface is small, and there is a plurality of states of the edge surface. That is, the second aspect regulates a method of manufacturing a graphite material having the above characteristics.

In general, as the method of manufacturing a graphite material, a method, in which raw coke or calcined coke is pulverized and classified, the particle size is adjusted, and then the particles are carburized and/or graphitized, thereby manufacturing a graphite material, is known. Here, the raw coke refers to a base oil composition thermally decomposed using delayed coker, and the calcined coke refers to coke obtained by thermally treating raw coke in an industrial furnace, and removing moisture or volatile components, thereby developing a crystal structure.

However, only with the above ordinary manufacturing method, that is, simply pulverizing and classifying raw coke or calcined coke, and then thermally treating the coke, it is not possible to obtain the graphite material regulated in the first aspect.

Therefore, as a result of studying the method of manufacturing a graphite material, the inventors and the like found that a graphite material, in which the edge surface exposed to the particle surface is small, and there is a plurality of states of the edge surface, is obtained by setting the size of the randomly laminated reticulated surfaces constituting raw coke or calcined coke being pulverized, that is, the size (hereinafter sometimes abbreviated to anisotropic area) of an optical anisotropic area to a relatively small size.

In a case in which the anisotropic area in raw coke or calcined coke being pulverized is small, dynamic energy supplied to the raw coke or calcined coke is absorbed in a gap area between the anisotropic areas. In the raw coke or calcined coke constituted by small-size anisotropic areas, since the gap area between the anisotropic areas is large, the supplied dynamic energy is sufficiently absorbed in the gap area between the anisotropic areas. Therefore, the probability of the reticulated plane breaking or the probability of cracking occurring in the reticulated plane is significantly suppressed. The amount of the edge surface exposed to the pulverized particle surface is small in a case in which the dynamic energy is absorbed in the gap area between the anisotropic areas compared to a case in which cracking is introduced into the reticulated plane.

In addition, in a case in which the dynamic energy is absorbed in the gap area between the anisotropic areas, a carbon-carbon bonding in unorganized carbon atoms which are present in the gap area between the anisotropic areas and have a structure other than benzene ring, which becomes the constituent unit of the reticulated plane, is broken. Since there is a plurality of bonding states in the carbon-carbon bonding, in a case in which the carbon-carbon bonding is broken due to the dynamic energy, a plurality of states of the edge surface is exposed to the cut surface. In addition, the plurality of states of the edge surface remains while maintaining the plurality of states even in a case in which a heating process is performed after pulverization and classification.

It becomes possible to decrease the edge surface exposed to the particle surface and to expose a plurality of states of the edge surface to the particle surface by pulverizing and classifying raw coke or calcined coke having a small anisotropic area in the above manner.

Conversely, in a case in which raw coke or calcined coke having a relatively large anisotropic area and a small gap area between the anisotropic areas is pulverized, since the dynamic energy is not sufficiently absorbed in the gap area between the anisotropic areas, cracking is introduced into the anisotropic area. In a case in which cracking is introduced in the anisotropic area in which the reticulated planes are oriented in a single direction, a number of the edge surfaces having a well-defined state are likely to be exposed to cracked surfaces. In a lithium ion secondary cell, for which the above graphite material is used, since a film formed by a decomposition reaction product is likely to be formed on the edge surface of the negative electrode, and the resistance component of the reversible intercalation reaction of Li ions increases, the internal resistance of a cell increases, and the service life characteristic degrades, which is not desirable.

For the above reasons, as the method of manufacturing the graphite material regulated in the first aspect, a manufacturing method, in which raw coke or calcined coke constituted by an anisotropic area having a relative small size is pulverized, classified, and then carburized and/or graphitized, is desirable.

Therefore, the second aspect according to the invention can also be said to specifically regulate a manufacturing method for making the pulverized raw coke or calcined coke into a structure constituted by an anisotropic area having a relatively small size. The inventors and the like found that raw coke having the above structure can be manufactured using a delayed coking process, which is suitable for mass production, by controlling the properties of a base oil composition, which is a source material, and the coking conditions, and completed the second aspect of the invention.

A base oil composition having the above properties can be obtained by performing a variety of processes so as to make a sole base oil satisfy the above conditions, or by blending two or more kinds of base oils so as to satisfy the above conditions. Examples of the base oil include the bottom oil (for example, fluid catalytic cracking decant oil, FCC DO) of a fluid catalytic cracker, the bottom oil (for example, high severity fluid catalytic cracking decant oil, HS-FCC DO) of a high severity fluid catalytic cracker, an aromatic content and a saturated content extracted from a fluid catalytic cracking decant oil, an aromatic content and a saturated content extracted from a high severity fluid catalytic cracking decant oil, a hydrodesulfurized oil obtained by performing a high hydrodesulfurization process on a base oil, a vacuum residual oil (for example, VR), a desulfurized deasphalted oil, coal-derived liquid, a solvent-extracted oil of coal, an atmospheric residual oil, a shale oil, a tar sand bitumen, a naphtha tar pitch, an ethylene bottom oil, a coal-tar pitch, a hydrorefined heavy oil, a light straight distilled oil, a heavy straight distilled oil, a hydrodesulfurized light oil, a catalytically-cracked light oil, a directly-desulfurized heavy oil, an indirectly-desulfurized heavy oil, a lubricant and the like. Among the above, a heavy oil, a light straight distilled oil, a heavy straight distilled oil, a hydrodesulfurized light oil, a catalytically-cracked light oil, a directly-desulfurized heavy oil, an indirectly-desulfurized heavy oil, a lubricant and the like, which include an appropriately saturated content and appropriate normal paraffin in the above saturated content, and is subjected to a high hydrodesulfurization process, can be preferably used as a gas-generating source during solidification.

In a case in which the above base oils are blended so as to prepare a base oil composition, the blending ratio may be appropriately adjusted depending on the properties of the base oil being used. Meanwhile, the properties of the base oil vary depending on the type of a crude oil, process conditions until the base oil is obtained from the crude oil, and the like.

The bottom oil of the fluid catalytic cracker is a bottom oil of a fluidized-bed fluid catalytic cracker for selectively performing a decomposition reaction using a catalyst and using a vacuum gas oil as a base oil to obtain high-octane FCC gasoline. The vacuum gas oil used as the base oil is preferably a desulfurized vacuum gas oil obtained by directly desulfurizing an atmospheric distillation residual oil, and more preferably a desulfurized vacuum gas oil with a sulfur content of 500 wt ppm or less and a density of 0.8 g/cm³ or more at 15° C.

The bottom oil of a high severity fluid catalytic cracker (hereinafter sometimes referred to as HS-FCC) is a bottom oil of HS-FCC that can further accelerate a decomposition reaction compared to the above fluid catalytic cracker. In HS-FCC, a base oil can be decomposed within a short period of time by bringing a catalyst and the base oil in a down flow reactor, in which the catalyst and the base oil flow in the same direction as gravitation at a reaction temperature of 600° C., and gasoline and olefins at a high yield can be obtained. The bottom oil of HS-FCC has a high aromatic index fa compared to other base oils.

The aromatic content extracted from the fluid catalytic cracking decant oil and the high severity fluid catalytic cracking decant oil is an aromatic content when a component is selectively extracted using dimethylformamide or the like, and is divided into an aromatic content and a saturated content.

The saturated content extracted from the fluid catalytic cracking decant oil and the high severity fluid catalytic cracking decant oil is a saturated content when n-heptane having the same volume of the fluid catalytic cracking decant oil and the high severity fluid catalytic cracking decant oil is added and mixed, then, the saturated content is selectively extracted using dimethyl formamide or the like, and is divided from the aromatic content.

The hydrodesulfurized oil obtained by performing a high hydrodesulfurization process on a heavy oil is, for example, a heavy oil with a sulfur content of 1.0 wt % or less, a nitrogen content of 0.5 wt % or less, and an fa, which is an aromatic index ratio, of 0.1 or more, which is obtained by performing a hydrodesulfurization process on a heavy oil with a sulfur content of 1 wt % or more at a hydrogen partial pressure of 10 MPa or more. The hydrodesulfurized oil is preferably a hydrodesulfurized oil obtained by hydrodesulfurizing an atmospheric distillation residual oil in the presence of a catalyst so as to have a hydrogenolysis rate of 25% or less.

The vacuum residual oil (hereinafter sometimes referred to as VR) is a bottom oil of a vacuum distillatory obtained by inputting a crude oil into an atmospheric distillatory to obtain gases, a light oil and an atmospheric residual oil, and then changing the atmospheric residual oil, for example, at a reduced pressure of 10 Torr to 30 Torr in a heating furnace outlet temperature in a range of 320° C. to 360° C.

The desulfurized deasphalted oil is obtained by, for example, processing an oil, such as vacuum distillation residual oil, by the use of a solvent deasphalting apparatus using propane, butane, pentane, a mixture thereof, or the like as a solvent, removing the asphaltene content, and desulfurizing the obtained deasphalted oil (hereinafter sometimes referred to DAO) preferably up to a sulfur content of 0.05 wt % to 0.40 wt % using an indirect desulfurizer (hereinafter sometimes referred to as Isomax).

The atmospheric residual oil is a fraction having the highest boiling point which is obtained by inputting a crude oil to an atmospheric distillatory and fractionally distilling the crude oil into gases and LPG, a gasoline fraction, a lamp oil fraction, a light oil fraction and an atmospheric residual oil depending on the boiling points of the fractions. The heating temperature varies depending on the producing area of the crude oil or the like and is not limited as long as the crude oil can be fractionally distilled into the fractions. For example, the crude oil is heated at 320° C.

The light straight distilled oil and the heavy straight distilled oil are a light or heavy light oil obtained by distilling a crude oil in an atmospheric distillatory at ordinary pressure.

The hydrodesulfurized oil is a light oil obtained by desulfurizing light straight distilled oil in a hydrodesulfurization apparatus.

The catalytically-cracked light oil is a light oil obtained from a fluid catalytic cracker, and is a fraction having a higher boiling point than a decomposed gasoline fraction.

The directly-desulfurized light oil is a light oil obtained by desulfurizing atmospheric residual oil in a direct desulfurization apparatus.

The indirectly-desulfurized light oil is a light oil obtained by desulfurizing vacuum gas oil in an indirect desulfurization apparatus.

A particularly preferable example of the base oil composition is a base oil composition satisfying three conditions of (1) an aromatic content ratio (aromatic index) fa of 0.30 to 0.65, (2) a normal paraffin content of 5.0 wt % to 20 wt %, and (3) a content of a HS-FCC oil of 3.0 wt % to 20 wt %.

The base oil is processed at high temperatures to cause pyrolytic reactions and polycondensation reactions and a raw coke is produced through a process of producing a large liquid crystal called a mesophase as an intermediate product. At this time, a base oil composition including all of (1) a base oil component forming an excellent bulk mesophase, (2) a heavy oil component which can produce a gas having a function of limiting the size of an anisotropic area constituting a mesophase when carbonizing and solidifying the bulk mesophase by polycondensation, and (3) a component bonding the anisotropic areas to each other can be particularly preferably used. The (1) base oil component forming an excellent bulk mesophase is a component giving an aromatic index fa of 0.30 to 0.65, the (2) base oil component which can produce a gas is a component corresponding to the normal paraffin content of 5.0 wt % to 20 wt %, and the (3) component bonding the anisotropic areas is a HS-FCC oil contained in the range of 3.0 wt % to 20 wt %.

The reason for using such a base oil composition as a source material of the raw coke of the invention is that an anisotropic area formed by the base oil component producing an excellent bulk mesophase is limited to a relatively small size to, in the subsequent thermal process, increase the interface between the bonding anisotropic areas, and bond the anisotropic areas using the HS-FCC oil.

When the above base oil component is coked, raw coke constituted by the anisotropic areas having a relatively small size is obtained, and, when the raw coke is further calcined at a high temperature, calcined coke constituted by the anisotropic areas having a relatively small size can be obtained.

Meanwhile, there is no example in which, when raw coke and calcined coke are manufactured, an HS-FCC cracked residual oil is added to a base oil composition that becomes a source material of the cokes, and it is a surprise that the inclusion of the HS-FCC cracked residual oil is effective.

The fa refers to the aromatic index ratio (fa) obtained through a Knight method. In the Knight method, a carbon distribution is divided into three components (A1, A2, A3) in a spectrum of an aromatic carbon using a ¹³C-NMR method. Here, A1 represents the number of carbons in an aromatic ring and substituted aromatic carbons and a half of non-substituted aromatic carbons (corresponding to peaks of about 40 to 60 ppm of ¹³C-NMR), A2 represents the other half of the non-substituted aromatic carbons (corresponding to peaks of about 60 to 80 ppm of ¹³C-NMR), and A3 represents the number of aliphatic carbons (corresponding to peaks of about 130 to 190 ppm of ¹³C-NMR). From these, fa is obtained from fa=(A1+A2)/(A1+A2+A3). The fact that the ¹³C-NMR method is the best method that can quantitatively obtain fa, which is the most fundamental amount of the chemical structure parameter of pitches, is described in the document (“The Characterization of Pitches II. Chemical structure”, Yokono, Sanada, (Carbon, 1981 (No. 105), P 73 to 81)).

In addition, the content of normal paraffin in the base oil composition means a value measured through the use of gas chromatography using a capillary column. Specifically, verification is performed using a standard reference material of normal paraffin and then a sample of a non-aromatic components separated by the elution chromatography is measured using the capillary column. The content based on the total weight of the base oil composition can be calculated from this measured value.

When the aromatic index fa is less than 0.30, the yield of coke from the base oil composition is extremely lowered, an excellent bulk mesophase is not formed, and it is difficult to develop a crystalline structure even after the carbonization and graphitization, which is not desirable. In a case in which fa is more than 0.65, plural mesophases are rapidly generated in a matrix in the course of producing a raw coke and rapid combination of mesophases is more repeated than single growth of mesophases. Accordingly, since the combination rate of the mesophases is higher than the generation rate of gases from the normal paraffin-containing component, it is not possible to limit an anisotropic area of a bulk mesophase to a small size, which is not desirable.

As described above, the aromatic index fa of the base oil composition is limited in a range of 0.30 to 0.65. Here, fa can be calculated from a density D and a viscosity V of a base oil composition, and fa of a base oil composition with a density D of 0.91 g/cm³ to 1.02 g/cm³ and with a viscosity V of 10 mm²/sec to 220 mm²/sec is preferably in a range of 0.30 to 0.65.

Meanwhile, the normal paraffin component appropriately included in the base oil composition performs an important function of limiting a bulk mesophase to a small size by generating gases during the coking process as described above.

When the content of the normal paraffin-containing component is less than 5.0 wt %, mesophases grow more than necessary and large anisotropic areas are formed, which is not desirable. In addition, when the content of the normal paraffin-containing component is more than 20 wt %, excessive gases are generated from the normal paraffin, the orientation of the bulk mesophase tends to be disturbed in the opposite direction, and it is thus difficult to develop the crystalline structure in spite of the carbonization and graphitization, which is not desirable. As described above, the content of the normal paraffin is limited in a range of 5.0 wt % to 20 wt %.

The HS-FCC cracked residual oil plays a role of appropriately bonding adjacent anisotropic areas as described above, and the content rate in the base oil composition is particularly preferably within a range of 3.0 wt % to 20 wt %. In a case in which the content rate is less than 3.0 wt %, in the thermal process, a strong carbon-carbon bond is not formed between adjacent anisotropic areas, and it is difficult for the crystal structure to develop, which is not desirable. In addition, in a case in which the content rate exceeds 20 wt %, large anisotropic areas are formed in raw coke or calcined coke obtained after the thermal process. In a case in which the raw coke or calcined coke is pulverized and classified, since the gap area between the anisotropic areas becomes extremely small, cracks are easily introduced into reticulated planes in the anisotropic areas, and the edge surface with a well-defined state is easily exposed to the particle surface. In a lithium ion secondary cell, for which the graphite material is used, since a thick film is formed on the edge surface in the negative electrode, and the resistance component of the reversible intercalation reaction of Li ions increases, the internal resistance of the cell increases, and the service life characteristic degrades, which is not desirable.

The base oil composition having this feature is coked to form the raw coke in the invention. A delayed coking method can be preferably used as a method of coking a base oil composition satisfying a predetermined condition. More specifically, a method of heating a base oil composition to obtain a raw coke through the use of a delayed coker under the condition of a controlled coking pressure can be preferably used. The preferable operating conditions of the delayed coker include a pressure of 0.1 MPa to 0.8 MPa and a temperature of 400° C. to 600° C.

The reason for setting the preferable range of the operating pressure of a coker is that the emission speed of gases generated from the normal paraffin-containing component to the outside of the system can be controlled by the use of the pressure. As described above, since the size of the anisotropic area constituting a mesophase is controlled by the use of the generated gases, the residence time of the generated gases in the system serves as an important control parameter for determining the size of the anisotropic area. In addition, the reason for setting the preferable range of the coker operating temperature is that it is a temperature necessary for causing a mesophase to grow from a base oil adjusted to achieve the advantageous effect of the invention.

The green coke obtained in the above manner is pulverized and classified so as to obtain a predetermined particle size. The particle size is preferably 30 μm or less in terms of the average particle diameter. The average particle diameter is based on the measurement using a laser diffraction-type particle size analyzer. The reason for setting the average particle size to 30 μm or less is that 30 μm is the particle size at which the green coke is generally and preferably used as a graphite material of a negative electrode of a lithium ion secondary cell. Furthermore, a preferable average particle diameter is within 5 μm to 30 μm. Since the specific surface area of a graphite material obtained by carburizing green coke having an average particle size of less than 5 μm is extremely large, in a lithium ion secondary cell, for which the above graphite material is used for the negative electrode, the contact area between the surface of the graphite material and the electrolytic solution becomes large in the negative electrode. In this case, the decomposition reaction of the electrolytic solution, in which the localized electrons in the negative electrode are used as a catalyst, becomes likely to occur, which is not preferable.

The method of a carburization process is not particularly limited, and, in general, examples thereof include a method in which a heating process is performed in an inert gas atmosphere, such as nitrogen, argon or helium, at a highest temperature of 900° C. to 1500° C. and a highest temperature retention time of 0 hour to 10 hours.

The method of a graphitization process is not particularly limited, and, in general, examples thereof include a method in which a heating process is performed in an inert gas atmosphere, such as nitrogen, argon or helium, at a highest temperature of 2500° C. to 3200° C. and a highest temperature retention time of 0 hour to 100 hours.

Meanwhile, in the past, there was no example in which a graphite material manufactured using an HS-FCC cracked residual oil as a source material was used as a negative electrode material of a lithium ion cell. In the invention, as a preferable embodiment of the base oil composition, it is possible to obtain raw coke and calcined coke which is mixed with an HS-FCC cracked residual oil, is constituted by anisotropic areas having a relatively small size, and has anisotropic areas appropriately bondable. When the obtained raw coke is pulverized, classified, carburized, and then graphitized, or the obtained calcined coke is pulverized, classified, and then graphitized, the graphite material according to the first aspect of the invention can be provided.

The method of manufacturing a negative electrode of a lithium ion secondary cell is not particularly limited but, for example, a method of pressing and shaping a mixture (negative-electrode mixture) including the graphite material according to the invention, a binder (binding agent), a conducting agent if necessary, and an organic solvent in a predetermined size can be used. The method of rolling a material (negative-electrode mixture), which is obtained by kneading the graphite material according to the invention, a binder, a conducting agent, and the like in an organic solvent to produce slurry and applying and drying the slurry onto a collector such as a copper foil, and cutting out the resultant in a predetermined size can be also used.

Examples of the binder, that is, the binding agent include polyvinylidene fluoride, polytetrafluoroethylene, polyacrylonitrile, polyethylene terephthalate, and styrene-butadiene rubber (hereinafter, sometimes referred to as SBR). The content of the binder in the negative-electrode mixture can be appropriately set to a range of about 1 to 30 parts by weight with respect to 100 parts by weight of a carbon material if necessary in design of a cell.

Examples of the conducting agent include carbon black, graphite, acetylene black, indium-tin oxide exhibiting conductivity, and conductive polymers such as polyaniline, polythiophene, and polyphenylenevinylene. The content of the conducting agent is preferably in a range of 1 to 15 parts by weight with respect to 100 parts by weight of a carbon material.

Examples of the organic solvent include dimethylformamide, N-methylpyrrolidone, pyrrolidone, N-methylthiopyrrolidone, hexamethylphosphoamide, dimethylacetamide, isopropanol, toluene and the like.

The method of mixing a carbon material, a binder, a conducting agent if necessary, and an organic solvent can employ a known apparatus such as a screw kneader, a ribbon mixer, a universal mixer, and a planetary mixer. The mixture is shaped through roll pressing or press pressing, and the pressure at that time is preferably in a range of 100 MPa to 300 MPa.

The material of the collector is not particularly limited as long as it does not form an alloy with lithium. Examples thereof include copper, nickel, titanium, and stainless steel. The shape of the collector is not particularly limited, but examples thereof include band shapes such as a foil shape, a punched foil shape, and a mesh shape. A porous material such as porous metal (foamed metal) or carbon paper can be used.

The method of applying the slurry onto the collector is not particularly limited, but examples thereof include known methods such as a metal mask printing method, an electrostatic coating method, a dip coating method, a spray coating method, a roll coating method, a doctor blade method, a gravure coating method, a screen printing method, and a die coater method. After the application, a rolling process using a flat press, a calender roll, or the like is generally performed if necessary.

In addition, the unification of the negative-electrode slurry shaped in a sheet shape or pellet shape and the collector can be performed using known methods such as rolling, pressing, and a combination thereof.

A lithium ion secondary cell using the graphite material for a negative electrode of a lithium ion secondary cell according to the embodiment is obtained, for example, by arranging the negative electrode manufactured as described above and the positive electrode to face each other with a separator therebetween, and injecting an electrolyte solution thereto.

The active material used for the positive electrode is not particularly limited, and, for example, a metal compound, a metal oxide, a metal sulfide or a conductive polymer material capable of doping or intercalating lithium ions can be used. Examples thereof include lithium cobalt oxide (LiCoO₂), lithium nickel oxide (LiNiO₂), lithium manganese oxide (LiMn₂O₄), lithium complex multiple oxide (LiCoₓNi_{y}M_{z}O₂, X+Y+Z=1, M indicates Mn, Al or the like), lithium complex multiple oxide in which some of the transition metals are substituted by other elements, a lithium vanadium compound, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, olivine-type LiMPO₄ (herein, M is any one of Co, Ni, Mn and Fe), conductive polymers, such as polyacetylene, polyaniline, polypyrrole, polythiophene and polyacene, porous carbon and mixtures thereof.

In the invention, the active material of the positive electrode is preferably iron-based or manganese-based active materials, and more preferably LiMn₂O₄ and LiFePO₄. In the active material, it is particularly preferable that approximately 0.01 to 0.1 Al atoms be incorporated into 1 Mn atom.

When the above positive electrode is used, it is possible to stably use the positive electrode even in a lithium ion cell at the last phase of the service life.

For example, an unwoven fabric, a cross, and a porous film including polyolefin such as polyethylene and polypropylene as a major component, or combinations thereof can be used as the separator. When the positive electrode and the negative electrode of a lithium ion secondary cell to be manufactured do not come in direct contact with each other, the separator does not have to be used.

Known organic electrolyte solutions, inorganic solid electrolytes, and polymer solid electrolytes can be used as the electrolyte solution and the electrolyte used for a lithium ion secondary cell. From the viewpoint of electric conductivity, the organic electrolyte solution can be preferably used.

Examples of the organic electrolyte solution include ethers such as dibutyl ether, ethyleneglycol monomethyl ether, ethyleneglycol monoethyl ether, ethyleneglycol monobutyl ether, diethyleneglycol monomethyl ether, and ethyleneglycol phenyl ether, amides such as N-methylformamide, N,N-dimethylformamide, N-ethylformamide, N,N-diethylformamide, N-methylacetamide, N,N-dimethylacetamide, N-ethylacetamide, and N,N-diethylacetamide, sulfur-containing compounds such as dimethylsulfoxide and sulfolane, dialkyl ketones such as methyl ethyl ketones and methylisobutyl ketone, cyclic ethers such as tetrahydrofurane and 2-methoxytetrahydrofurane, cyclic carbonates such as ethylene carbonate, butylene carbonate, propylene carbonate, and vinylene carbonate, chained carbonate such as diethyl carbonate, dimethyl carbonate, methylethyl carbonate, and methylpropyl carbonate, cyclic ester carbonates such as γ-butyrolactone and γ-valerolactone, chained ester carbonates such as methyl acetate, ethyl acetate, methyl propionate, and ethyl propionate, and organic solvents such as N-methyl 2-pyrrolidinone, acetonitrile, and nitromethane. These solvents can be used singly or in combination of two or more.

Various lithium salts can be used as a solute of the solvents. Examples of a known lithium salt include LiClO₄, LiBF₄, LiPF₆, LiAlCl₄, LiSbF₆, LiSCN, LiCl, LiCF₃SO₃, LiCF₃CO₂, LiN(CF₃SO₂)₂, and LiN(C₂F₅SO₂)₂.

Examples of the polymer solid electrolyte include polyethylene oxide derivatives and polymers including the derivatives, polypropylene oxide derivatives and polymers including the derivatives, ester phosphate polymers, and polycarbonate derivatives and polymers including the derivatives.

Selection of members necessary for the configuration of a cell other than the above-mentioned ones is not limited at all.

The structure of the lithium ion secondary cell is not particularly limited, but a structure in which a winding electrode group in which a positive electrode and a negative electrode formed in a band shape are spirally wound with a separator interposed therebetween is inserted into a cell case and the resultant is sealed or a structure in which a positive electrode and a negative electrode formed in a flat panel shape are sequentially stacked with a separator interposed therebetween is enclosed in a case is generally employed. The lithium ion secondary cell can be used, for example, as a paper type cell, a button type cell, a coin type cell, a laminated cell, a cylindrical cell, and a square cell.

A lithium ion secondary cell, for which the graphite material of the invention is used as the negative electrode material, can secure an extremely high degree of reliability compared to a lithium secondary cell, for which a graphite material of the related art is used, and thus can be used for industrial use, such as vehicles, specifically, hybrid cars, plug-in hybrid cars and electric cars; and power storage of a system infrastructure.

### EXAMPLES

Hereinafter, the invention will be described more specifically based on examples and comparative examples, but the invention is not limited to the following examples.

1. Raw Coke and a Method of Manufacturing the Same

(1) Raw Coke A

Hydrodesulfurized oil (sulfur content: 500 wt ppm, density at 15° C.: 0.88 g/cm³; this shall apply in the following examples) was fluid-catalytically cracked so as to obtain a fluid catalytic cracking decant oil. The same volume of n-heptane was added to and mixed with the obtained fluid catalytic cracking decant oil, the mixture was selectively extracted using dimethylformamide so as to divide into an aromatic content and a saturated content, the saturated content among the above was selectively extracted, and used as a saturated content extracted from the fluid catalytic cracking decant oil. In addition, hydrodesulfurized oil (sulfur content: 500 wt ppm, density at 15° C.: 0.88 g/cm³) was fluid-catalytically cracked in a high severity fluid catalytic cracker (HS-FCC) so as to obtain a HS-FCC decant oil.

Next, HS-FCC decant oil was added to a mixture of the fluid catalytic cracking decant oil and the saturated contents extracted from the fluid catalytic cracking decant oil mixed at 4:1 so as to reach 3 wt % (the entire mixture including the HS-FCC decant oil was 100 wt %), thereby obtaining a base oil composition which became a source material of coke. The normal paraffin content and aromatic index fa of the base oil composition are described in Table 1. The base oil composition was introduced into a delayed coker unit, and coked at 550° C. in an inert gas atmosphere, thereby obtaining raw coke A.

(2) Raw Coke B

HS-FCC decant oil was added to a mixture of the fluid catalytic cracking decant oil and the saturated contents extracted from the fluid catalytic cracking decant oil mixed at 3:1 so as to reach 2 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke B.

(3) Raw Coke C

HS-FCC decant oil was added to a mixture of the fluid catalytic cracking decant oil and the saturated contents extracted from the fluid catalytic cracking decant oil mixed at 1:1 so as to reach 3 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke C.

(4) Raw Coke D

HS-FCC decant oil was added to a mixture of the fluid catalytic cracking decant oil and hydrodesulfurized oil mixed at a weight ratio of 5:1 so as to reach 7 wt % (the entire mixture including the HS-FCC decant oil was 100 wt %), thereby obtaining a base oil composition that became a source material of coke. Reduce crude having 3.1 wt % of a sulfur content was hydrodesulfurized in the presence of a catalyst so that the hydrogenolysis rate became 25% or less, thereby obtaining hydrodesulfurized oil. In addition, the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke D.

(5) Raw Coke E

HS-FCC decant oil was added to a mixture of the fluid catalytic cracking decant oil and light straight distilled oil mixed at 6:1 so as to reach 6 wt % (the entire mixture including the HS-FCC decant oil was 100 wt %), thereby obtaining a base oil composition that became a source material of coke. Light straight distilled oil was obtained by distilling crude oil at ordinary pressure in an atmospheric distillatory. The other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke E.

(6) Raw Coke F

HS-FCC decant oil was added to a mixture of the fluid catalytic cracking decant oil and the aromatic contents extracted from the fluid catalytic cracking decant oil mixed at a weight ratio of 6:1 so as to reach 9 wt % (the entire mixture including the HS-FCC decant oil was 100 wt %), thereby obtaining a base oil composition that became a source material of coke. The fluid catalytic cracking decant oil was selectively extracted using dimethylformamide so as to divide into an aromatic content and a saturated content, the saturated content among the above was selectively extracted, and used as a saturated content extracted from the fluid catalytic cracking decant oil. In addition, the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke F.

(7) Raw Coke G

HS-FCC decant oil was added to a mixture of the fluid catalytic cracking decant oil and the saturated contents extracted from the fluid catalytic cracking decant oil mixed at a weight ratio of 3:2 so as to reach 6 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke G.

(8) Raw Coke H

HS-FCC decant oil was added to a mixture of the fluid catalytic cracking decant oil and the saturated contents extracted from the fluid catalytic cracking decant oil mixed at a weight ratio of 6:5 so as to reach 8 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke H.

(9) Raw Coke I

HS-FCC decant oil was added to a mixture of the fluid catalytic cracking decant oil and hydrodesulfurized oil mixed at a weight ratio of 1:1 so as to reach 13 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke I.

(10) Raw Coke J

HS-FCC decant oil was added to a mixture of the fluid catalytic cracking decant oil and the saturated contents extracted from the fluid catalytic cracking decant oil mixed at a weight ratio of 2:3 so as to reach 15 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke J.

(11) Raw Coke K

HS-FCC decant oil was added to a mixture of the fluid catalytic cracking decant oil and light straight distilled oil mixed at a weight ratio of 8:1 so as to reach 18 wt % (the entire mixture including the HS-FCC decant oil was 100 wt %), thereby obtaining a base oil composition that became a source material of coke. The light straight distilled oil was obtained in the same manner as the method of manufacturing the raw coke E, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke K.

(12) Raw Coke L

HS-FCC decant oil was added to a mixture of the fluid catalytic cracking decant oil and light straight distilled oil mixed at a weight ratio of 4:1 so as to reach 15 wt % (the entire mixture including the HS-FCC decant oil was 100 wt %), thereby obtaining a base oil composition that became a source material of coke. The light straight distilled oil was obtained in the same manner as the method of manufacturing the raw coke E, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke L.

(13) Raw Coke M

HS-FCC decant oil was added to a mixture of the fluid catalytic cracking decant oil and light straight distilled oil mixed at a weight ratio of 2:1 so as to reach 18 wt % (the entire mixture including the HS-FCC decant oil was 100 wt %), thereby obtaining a base oil composition that became a source material of coke. The light straight distilled oil was obtained in the same manner as the method of manufacturing the raw coke E, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke M.

(14) Raw Coke N

HS-FCC decant oil was added to a mixture of the fluid catalytic cracking decant oil and hydrodesulfurized oil mixed at a weight ratio of 7:1 so as to reach 21 wt % (the entire mixture including the HS-FCC decant oil was 100 wt %), thereby obtaining a base oil composition that became a source material of coke. The hydrodesulfurized oil was obtained in the same manner as the method of manufacturing the raw coke D, and the other base oils were obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke N.

(15) Raw Coke O

HS-FCC decant oil was added to a mixture of the fluid catalytic cracking decant oil and the saturated contents extracted from the fluid catalytic cracking decant oil mixed at a weight ratio of 10:1 so as to reach 24 wt % (the entire mixture including the HS-FCC decant oil was 100 wt %), thereby obtaining a base oil composition that became a source material of coke. The saturated contents extracted from the fluid catalytic cracking decant oil was obtained in the same manner as the method of manufacturing the raw coke F, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke O.

(16) Raw Coke P

HS-FCC decant oil was added to a mixture of the fluid catalytic cracking decant oil and the saturated contents extracted from the fluid catalytic cracking decant oil mixed at a weight ratio of 10:3 so as to reach 15 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke P.

(17) Raw Coke Q

HS-FCC decant oil was added to a mixture of the fluid catalytic cracking decant oil and the saturated contents extracted from the fluid catalytic cracking decant oil mixed at a weight ratio of 5:2 so as to reach 17 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke Q.

(18) Raw Coke R

HS-FCC decant oil was added to a mixture of the fluid catalytic cracking decant oil and the saturated contents extracted from the fluid catalytic cracking decant oil mixed at a weight ratio of 2:1 so as to reach 23 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke R.

(19) Raw Coke S

HS-FCC decant oil was added to a mixture of the fluid catalytic cracking decant oil and the aromatic contents extracted from the fluid catalytic cracking decant oil mixed at a weight ratio of 6:1 so as to reach 7 wt % (the entire mixture including the HS-FCC decant oil was 100 wt %), thereby obtaining a base oil composition that became a source material of coke. The aromatic contents extracted from the fluid catalytic cracking decant oil was obtained in the same manner as the method of manufacturing the raw coke F, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke S.

(20) Raw Coke T

HS-FCC decant oil was added to a mixture of the fluid catalytic cracking decant oil and the saturated contents extracted from the fluid catalytic cracking decant oil mixed at a weight ratio of 5:1 so as to reach 22 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke T.

(21) Raw Coke U

HS-FCC decant oil was added to a mixture of the fluid catalytic cracking decant oil and the saturated contents extracted from the fluid catalytic cracking decant oil mixed at a weight ratio of 5:1 so as to reach 1 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke U.

(22) Raw Coke V

HS-FCC decant oil was added to a mixture of the fluid catalytic cracking decant oil and light straight distilled oil mixed at a weight ratio of 3:4 so as to reach 9 wt % (the entire mixture including the HS-FCC decant oil was 100 wt %), thereby obtaining a base oil composition that became a source material of coke. The light straight distilled oil was obtained in the same manner as the method of manufacturing the raw coke E, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke V.

(23) Raw Coke W

HS-FCC decant oil was added to a mixture of the fluid catalytic cracking decant oil and hydrodesulfurized oil mixed at a weight ratio of 3:2 so as to reach 2 wt % (the entire mixture including the HS-FCC decant oil was 100 wt %), thereby obtaining a base oil composition that became a source material of coke. The hydrodesulfurized oil was obtained in the same manner as the method of manufacturing the raw coke D, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke W.

(24) Raw Coke X

HS-FCC decant oil was added to a mixture of the fluid catalytic cracking decant oil and hydrodesulfurized oil mixed at a weight ratio of 4:5 so as to reach 4 wt % (the entire mixture including the HS-FCC decant oil was 100 wt %), thereby obtaining a base oil composition that became a source material of coke. The hydrodesulfurized oil was obtained in the same manner as the method of manufacturing the raw coke D, and the other base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke X.

(25) Raw Coke Y

HS-FCC decant oil was added to a mixture of the fluid catalytic cracking decant oil and the saturated contents extracted from the fluid catalytic cracking decant oil mixed at a weight ratio of 3:5 so as to reach 2 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke Y.

(26) Raw Coke Z

HS-FCC decant oil was added to a mixture of the fluid catalytic cracking decant oil and the saturated contents extracted from the fluid catalytic cracking decant oil mixed at a weight ratio of 4:3 so as to reach 2 wt % (the entire mixture including the HS-FCC decant oil was 100 wt %), thereby obtaining a base oil composition that became a source material of coke. Base oils were all obtained in the same manner as the method of manufacturing the raw coke A. The normal paraffin content and aromatic index fa of the base oil composition are described in Table 1. The base oil composition was introduced into a delayed coker unit, and coked at 550° C. in an inert gas atmosphere, thereby obtaining raw coke Z.

### Examples 1 to 9 and Comparative Examples 1 to 17

By pulverizing raw coke described in Table 1 by the use of a mechanical pulverizer (super rotor mill made by Nisshin Engineering Inc.) and classifying the resultant by the use of a precision air classifier (turbo classifier made by Nisshin Engineering Inc.), a powder of the raw coke with an average particle diameter of 12 was obtained. Here, the average particle diameter of the powder of the raw coke composition was measured using a laser diffraction/scattering particle size analyzer LA950 made by Horiba Ltd.

The compound powder was carbonized in the nitrogen gas flow under the conditions of a highest temperature of 1200° C. and a highest temperature retention time of 5 hours by the use of a roller hearth kiln made by Takasago Industry Co., Ltd. The obtained carbon material was input to a crucible, the crucible was installed in an electric furnace, and the resultant was graphitized in the nitrogen gas flow of 80 L/min at the highest temperature of 2800° C. At this time, the temperature rising rate was set to 200° C./h, the highest temperature retention time was set to 3 hours, and the temperature falling rate was set to 100° C./h to 1000° C., and the resultant was cooled to room temperature in a state in which the nitrogen gas flow was maintained, whereby a graphite material was obtained.

### Examples 10 and 11

The raw coke G was introduced into a rotary kiln, and carburized at 1400° C., thereby obtaining calcined coke. The obtained calcined coke was pulverized using a mechanical pulverizer (SUPER ROTOR MILL/made by Nisshin Engineering Inc.), and classified using a precision air classifier (TURBO CLASSIFIER/made by Nisshin Engineering Inc.), thereby obtaining carbon materials having average particle diameters of 12 μm (Example 10) and 6.0 μm (Example 11). These powders were injected into a crucible, installed in an electric furnace, and graphitized in a nitrogen gas flow of 80 L/minute at a highest temperature of 2800° C. At this time, the temperature increase rate was set to 200° C./hour, the highest temperature retention time was set to 3 hours, and the powders were cooled to 1000° C. at a temperature decrease rate of 100° C./hour, and then cooled to room temperature in the air in a state in which the nitrogen flow was held, thereby obtaining a graphite material. The average particle diameters of the obtained graphite materials were measured using a laser diffraction/scattering-type particle size distribution measuring apparatus LA950 made by Horiba Ltd, and were 12 μm (Example 10) and 6.0 μm (Example 11) respectively, which showed that there was no change from those of the carbon materials before the graphitization process. The crystallite sizes Lc (112) of the (112) diffraction line measured using an X-ray wide-angle diffraction method of the graphite materials were 9.1 nm (Example 10) and 8.9 nm (Example 11).

(1) The Properties of the Base Oil Composition

The content rate of normal paraffin in the base oil composition was measured using a gas chromatography mounted with a capillary column. Specifically, normal paraffin was verified using a standard substance, and then a specimen of the non-aromatic content divided using the elution chromatography method was measured using the capillary column. The content rate, for which the total weight of the base oil composition was used as a reference, was calculated from the measured value.

The aromatic index fa was performed using a Knight method. Specifically, the distribution of carbon was divided into three components (A1, A2 and A3) as the spectra of aromatic carbon obtained using a ¹³C-NMR method, and fa was obtained from fa=(A1+A2)/(A1+A2+A3) using the three components. Here, A1 represents the number of carbons in an aromatic ring and substituted aromatic carbons and a half of non-substituted aromatic carbons (corresponding to peaks of about 40 to 60 ppm of ¹³C-NMR), A2 represents the other half of the non-substituted aromatic carbons (corresponding to peaks of about 60 to 80 ppm of ¹³C-NMR), and A3 represents the number of aliphatic carbons (corresponding to peaks of about 130 to 190 ppm of ¹³C-NMR).

The normal paraffin content and aromatic index fa of the base oil composition are as described in Table 1.

(2) Calculation of Crystallite Size Lc (112) of Graphite Material

A Si standard sample of 5 wt % as an internal standard was mixed into the obtained graphite material, was filled in a glass rotating sample holder (diameter 25 mm×thickness 0.2 mm), was subjected to measurement using a wide-angle X-ray diffraction method on the basis of a method (Carbon 2006, No. 221, P 52 to P 60) defined by the 117 committee of Japan Society for the Promotion of Science, and the crystallite size Lc (112) of the graphite material was calculated. ULTIMA IV made by Rigaku Corporation was used as an X-ray diffractometer, a CuKα ray (using Kβ filter-Ni) was used as an X-ray source, the application voltage and the application current to an X-ray bulb were set to 40 kV and 40 mA.

The obtained diffraction pattern was analyzed by the use of the method (Carbon 2006, No. 221, P 52 to P 60) defined by the 117 committee of the Japan Society for the Promotion of Science. Specifically, the measured data was subjected to a smoothing process, a background removing process, an absorption correcting process, a polarization correcting process, and a Lorentz correcting process, the (112) diffraction line of the graphite material was corrected using the peak position and the value width of a (422) diffraction line of the Si standard sample, and the crystallite size was calculated. The crystallite size was calculated from the half-value width of the corrected peak using the following Scherrer's formula. The measurement and analysis were carried out three times and the average value thereof was set as the Lc (112). The measurement results of Lc (112) the graphite materials are shown in Table 1.

[Expression 1]

L=K×λ/(β0×cos θB) Scherrer's formula

Here, L: crystal size (nm)

K: form factor constant (=1.0)

λ: wavelength of an X-ray (=0.15406 nm)

θB: black angle β0: half-value width (corrected value)

(3) ESR Measurement of the Graphite Material

The graphite material (2.5 mg) was fed into a specimen tube, the specimen tube was vacuumed using a rotary pump, and then He gas was sealed in the specimen tube, thereby performing ESR measurement. As an ESR apparatus, a micro low-frequency counter, a Gauss meter and a cryostat, an ESP350E made by Bruker Corporation, an HP5351P made by Hewlett Packard Company, an ER035M made by Bruker Corporation, and an ESR910 made by Oxford Instruments were used. An X band (9.47 GHz) was used as the microwave, and the measurement was performed at an intensity of 1 mW, a central magnetic field of 3360 G, and a magnetic field modulation of 100 kHz. The ESR measurement was performed at two measurement temperatures of 4.8 K and 40 K.

The results of the signal intensities and line width ΔHpp of the ESR spectra of the graphite materials obtained in the examples and the comparative examples are as described in Table 2. The signal intensity was obtained by integrating the ESR spectrum twice. In addition, a scanning value of the gap between two peaks (maximum and minimum) in the ESR spectrum (derivative curve) was used as the line width ΔHpp.

Further, it was confirmed that the carbon-derived spectra, which were measured using an X band and appeared in an electron spin resonance technique, were in a range of 3200 gauss (G) to 3400 gauss (G) in both the examples and the comparative examples.

TABLE 1

| | Property of base | | | | |
|---|---|---|---|---|---|
| | oil composition | | | | |
| | | Normal par- | | Carbonizing | Graphitization |
| | fa | affin content | Raw | temperature | temperature |
| | (—) | (wt %) | coke | (° C.) | (° C.) |
| Example 1 | 0.30 | 5.0 | A | 1200 | 2800 |
| Example 2 | 0.30 | 10 | B | 1200 | 2800 |
| Example 3 | 0.30 | 20 | C | 1200 | 2800 |
| Example 4 | 0.49 | 5.0 | F | 1200 | 2800 |
| Example 5 | 0.45 | 13 | G | 1200 | 2800 |
| Example 6 | 0.46 | 20 | H | 1200 | 2800 |
| Example 7 | 0.65 | 5.0 | K | 1200 | 2800 |
| Example 8 | 0.65 | 14 | L | 1200 | 2800 |
| Example 9 | 0.65 | 20 | M | 1200 | 2800 |
| Example 10 | 0.45 | 13 | G | 1400 | 2800 |
| Example 11 | 0.45 | 13 | G | 1400 | 2800 |
| Comparative | 0.40 | 2.4 | D | 1200 | 2800 |
| example 1 | | | | | |
| Comparative | 0.45 | 4.0 | E | 1200 | 2800 |
| example 2 | | | | | |
| Comparative | 0.47 | 21 | I | 1200 | 2800 |
| example 3 | | | | | |
| Comparative | 0.50 | 25 | J | 1200 | 2800 |
| example 4 | | | | | |
| Comparative | 0.67 | 14 | N | 1200 | 2800 |
| example 5 | | | | | |
| Comparative | 0.79 | 2.4 | O | 1200 | 2800 |
| example 6 | | | | | |
| Comparative | 0.82 | 17 | P | 1200 | 2800 |
| example 7 | | | | | |
| Comparative | 0.80 | 24 | Q | 1200 | 2800 |
| example 8 | | | | | |
| Comparative | 0.95 | 27 | R | 1200 | 2800 |
| example 9 | | | | | |
| Comparative | 0.51 | 2.8 | S | 1200 | 2800 |
| example 10 | | | | | |
| Comparative | 0.97 | 8.0 | T | 1200 | 2800 |
| example 11 | | | | | |
| Comparative | 0.10 | 4.6 | U | 1200 | 2800 |
| example 12 | | | | | |
| Comparative | 0.19 | 26 | V | 1200 | 2800 |
| example 13 | | | | | |
| Comparative | 0.14 | 2.0 | W | 1200 | 2800 |
| example 14 | | | | | |
| Comparative | 0.20 | 16 | X | 1200 | 2800 |
| example 15 | | | | | |
| Comparative | 0.12 | 22 | Y | 1200 | 2800 |
| example 16 | | | | | |
| Comparative | 0.29 | 12 | Z | 1200 | 2800 |
| example 17 | | | | | |

Manufacturing of Cell and Evaluation of Characteristics

(1) Method of Manufacturing Cell

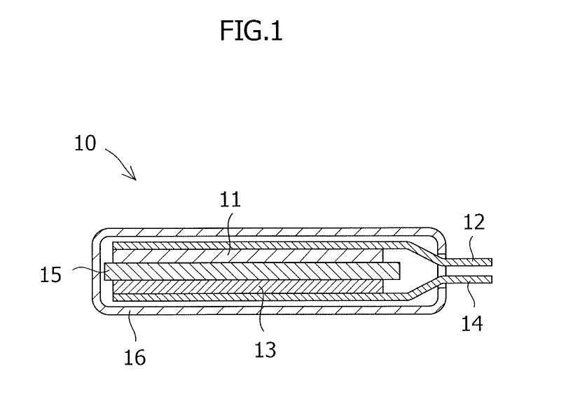

FIG. 1 is a cross-sectional view illustrating a manufactured cell 10. In FIG. 1, a negative electrode 11, a negative electrode collector 12, a positive electrode 13, a positive electrode collector 14, a separator 15, and an aluminum laminate package 16 are illustrated.

A positive electrode 13 is a sheet electrode obtained by mixing lithium manganese oxide Li[Li_{0.1}Al_{0.1}Mn_{1.8}]O₄ with an average particle diameter of 10 μm as a positive electrode material, polyvinylidene fluoride (KF#1320 made by Kureha Corporation) as a binder, and acetylene black (Denka Black made by Denki Kagaku Kogyo Kabushiki Kaisha) at a weight ratio of 89:6:5, adding N-methyl-2-pyrrolidinone thereto, kneading and forming the resultant in a paste form, applying the paste to one surface of an aluminum foil with a thickness of 30 μm, and performing a drying process and a rolling process thereon, and cutting the resultant so that the size of the applied portion includes a width of 30 mm and a length of 50 mm. At this time, the amount of application per unit area was set to 10 mg/cm² in terms of the weight of lithium nickel oxide.

A positive electrode mixture is removed perpendicularly to the length direction of the sheet from a part of the sheet electrode, the exposed aluminum foil is unified with and connected to the positive electrode collector 14 (the aluminum foil) of the applied portion and serves as a positive electrode lead plate.

A negative electrode 11 is a sheet electrode obtained by mixing the graphite materials obtained in Examples 1 to 11 and Comparative Examples 1 to 19 as a negative electrode material obtained in the examples and the comparative examples, polyvinylidene fluoride (KF#9310 made by Kureha Corporation) as a binder, and acetylene black (Denka Black made by Denki Kagaku Kogyo Kabushiki Kaisha) at a weight ratio of 91:2:8, adding N-methyl-2-pyrrolidinone thereto, kneading and forming the resultant in a paste form, applying the paste to one surface of a copper foil with a thickness of 18 μm, and performing a drying process and a rolling process thereon, and cutting the resultant so that the size of the applied portion includes a width of 32 mm and a length of 52 mm. At this time, the amount of application per unit area was set to 6 mg/cm² in terms of the weight of the graphite material.

A negative electrode mixture is removed perpendicularly to the length direction of the sheet from a part of the sheet electrode, the exposed copper foil is unified with and connected to the negative electrode collector 12 (the copper foil) of the applied portion and serves as a negative electrode lead plate.

A cell 10 is assembled in a state in which the positive electrode 13, the negative electrode 11, the separator 15, and other components are sufficiently dried and are introduced into a glove box filled with argon gas with a dew point of −100° C. The drying conditions of the positive electrode 13 and the negative electrode 11 include a depressurized state, 150° C., and 12 hours or more and the drying conditions of the separator 15 and other components include a depressurized state, 70° C., and 12 hours or more.

The dried positive electrode 13 and the dried negative electrode 11 were stacked and fixed with a polyimide tape in a state in which the applied portion of the positive electrode 13 and the applied portion of the negative electrode 11 face each other with a micro-porous film (#2400 made by Celgard LLC.), which is formed of polypropylene, interposed therebetween. Regarding the laminated positional relationship of the positive electrode 13 and the negative electrode 11, they were made to face each other so that the peripheral edge of the applied portion of the positive electrode projected onto the applied portion of the negative electrode 11 was surrounded with the inside of the peripheral edge of the applied portion of the negative electrode 11. The obtained single-layered electrode member is embedded in an aluminum laminate film, an electrolyte solution is injected thereto, and the laminate film was thermally fused in a state in which the positive and negative electrode lead plates protrude, whereby a closed single-layered laminate cell 10 was manufactured. The used electrolyte solution was obtained by dissolving lithium hexafluorophosphate (LiPF6) in a solvent in which ethylene carbonate and ethylmethyl carbonate were mixed at a volume ratio of 3:7 so as to form a concentration of 1 mol/L.

(2) Method of Evaluating Cell

The obtained cell was set into a thermostatic chamber of 25° C. and the following charging and discharging test was performed.

First, a static current charging operation was performed with a current of 1.5 mA until the cell voltage reaches 4.2 V. After a 10 minute pause, a static current discharging operation was performed with the same current until the cell voltage reaches 3.0 V. This charging and discharging cycle was repeatedly performed 10 times. Since this charging and discharging cycle is a preliminary test for checking abnormality of the cell, this charging and discharging cycle was not included in the number of cycles of the charging and discharging test in the examples and the comparative examples. It was confirmed in the preliminary test that all the cells manufactured in the examples and the comparative examples did not have any abnormality and then the main test was performed.

In the main test, the static current/static voltage charging operation with a charging current of 15 mA, a charging voltage of 4.2 V, and a charging time of 3 hours was performed and the static current discharging operation was performed with the same current (15 mA) until the cell voltage reaches 3.0 V after a 1 minute pause. The charging and discharging cycle under the same conditions was repeatedly performed five times and the discharging capacity of the fifth cycle was defined as an “initial discharging capacity. In the sixth cycle, the cell was set into a thermostatic chamber of 60° C. in a state in which the charging operation was performed under the same conditions and was left therein for 90 days. Thereafter, the thermostatic chamber was set to 25° C., the cell was left for 5 hours, and then was discharged. Then, the charging and discharging cycle under the same conditions as described above was repeatedly performed five times, and the discharging capacity of the fifth cycle was defined as a “90-days discharging capacity”. The ratio (%) of the “60° C. discharging capacity” to the “initial discharging capacity” was calculated as an index indicating the storage characteristics and was defined as a “90-days capacity retention rate (%)”.

Consideration Regarding the Test Results

The properties of the graphite materials described in the examples and the comparative examples and the characteristics of lithium ion secondary cells, for which the graphite materials are used, are described in Table 2. As the properties of the obtained graphite materials, “the signal intensity ratio” (a relative signal intensity ratio (I_{4.8K}/I_{40K}) of the signal intensity (I_{4.8K}) at a temperature of 4.8 K to the signal intensity (I_{40K}) of the spectrum measured at a temperature of 40 K) obtained using the ESR measurement, “the line width ΔHpp” (the line width of the spectrum calculated from the primary derivative spectrum at a temperature of 4.8 K), “Lc (112)” (the crystallite size in a c-axis direction calculated from a (112) diffraction line of the graphite material measured using powder X-ray diffraction method) are described.

In addition, “the initial discharging capacity (mAh)”, “the 90-days discharging capacity (mAh)” and “the 90-days capacity retention rate” (%) at the time of evaluating the cell characteristics are described.

TABLE 2

| | Properties of a graphite material | | | | | |
|---|---|---|---|---|---|---|
| | ESR spectrum | | | Cell characteristics | | |
| | Signal | | | Initial | 90-days | 90-days |
| | intensity | line width | XRD | discharging | discharging | capacity |
| | ratio | ΔHpp | Lc(112) | capacity | capacity | retention rate |
| | (—) | (G) | (nm) | (mAh) | (mAh) | (%) |
| Example 1 | 3.0 | 20 | 6.2 | 19.7 | 17.7 | 89.9 |
| Example 2 | 3.0 | 28 | 6.3 | 19.7 | 18.0 | 91.4 |
| Example 3 | 3.0 | 40 | 7.3 | 20.0 | 18.0 | 90.2 |
| Example 4 | 2.1 | 20 | 7.9 | 20.2 | 18.4 | 91.3 |
| Example 5 | 2.0 | 30 | 8.8 | 20.4 | 18.9 | 92.3 |
| Example 6 | 2.2 | 40 | 8.9 | 20.5 | 18.6 | 91.0 |
| Example 7 | 1.5 | 20 | 9.2 | 20.6 | 18.3 | 89.2 |
| Example 8 | 1.5 | 26 | 20 | 23.9 | 21.8 | 91.5 |
| Example 9 | 1.5 | 40 | 30 | 26.8 | 24.3 | 90.6 |
| Example 10 | 2.6 | 24 | 9.1 | 20.5 | 18.4 | 89.6 |
| Example 11 | 2.9 | 21 | 8.9 | 20.5 | 18.3 | 89.2 |
| Comparative | 2.4 | 8.0 | 7.3 | 19.0 | 13.5 | 71.3 |
| example 1 | | | | | | |
| Comparative | 2.3 | 14 | 7.4 | 19.0 | 13.4 | 70.2 |
| example 2 | | | | | | |
| Comparative | 2.4 | 42 | 9.1 | 19.5 | 13.8 | 70.8 |
| example 3 | | | | | | |
| Comparative | 2.3 | 57 | 9.3 | 20.6 | 13.4 | 65.1 |
| example 4 | | | | | | |
| Comparative | 1.4 | 30 | 20 | 22.9 | 15.8 | 69.1 |
| example 5 | | | | | | |
| Comparative | 0.9 | 29 | 10 | 20.9 | 13.0 | 62.1 |
| example 6 | | | | | | |
| Comparative | 0.7 | 32 | 19 | 22.5 | 14.2 | 63.2 |
| example 7 | | | | | | |
| Comparative | 0.8 | 55 | 25 | 23.9 | 16.7 | 69.8 |
| example 8 | | | | | | |
| Comparative | 0.3 | 66 | 30 | 25.5 | 15.5 | 60.6 |
| example 9 | | | | | | |
| Comparative | 1.7 | 38 | 7.6 | 19.1 | 13.2 | 69.3 |
| example 10 | | | | | | |
| Comparative | 0.4 | 19 | 30 | 25.8 | 15.5 | 60.2 |
| example 11 | | | | | | |
| Comparative | 4.2 | 17 | 4.0 | 18.0 | 12.7 | 70.8 |
| example 12 | | | | | | |
| Comparative | 3.5 | 57 | 6.8 | 19.2 | 11.8 | 61.2 |
| example 13 | | | | | | |
| Comparative | 3.6 | 7.0 | 5.8 | 19.1 | 13.0 | 68.1 |
| example 14 | | | | | | |
| Comparative | 3.4 | 33 | 6.6 | 19.3 | 13.5 | 70.2 |
| example 15 | | | | | | |
| Comparative | 3.7 | 43 | 4.3 | 18.1 | 12.6 | 69.9 |
| example 16 | | | | | | |
| Comparative | 3.1 | 31 | 6.5 | 19.8 | 14.3 | 72.3 |
| example 17 | | | | | | |

The graphite materials obtained using the manufacturing methods described in Examples 1 to 11 all satisfied that Lc (112), which is the crystallite size in a c-axis direction calculated from a (112) diffraction line of the graphite material measured using powder X-ray diffraction method, was within 4.0 nm to 30 nm, a carbon-derived spectrum appeared in a range of 3200 gauss (G) to 3400 gauss (G) in electron spin resonance spectroscopy, which was measured using an X band, the relative signal intensity ratio (I_{4.8K}/I_{40K}) of the signal intensity (I_{4.8K}) at a temperature of 4.8 K to the signal intensity (I_{40K}) of the spectrum measured at a temperature of 40 K was within 1.5 to 3.0, and the line width (ΔHpp) of the spectrum calculated from a primary derivative spectrum of the temperature of 4.8 K was within 20 gauss (G) to 40 gauss (G) (Table 2). It was found from the fact that the 90-days capacity retention rate of the cell, for which the graphite material was used as the negative electrode, was 89% or more (Table 2) that, when the graphite material according to the invention is used, it is possible to realize a lithium ion secondary cell that is extremely superior in terms of the service life characteristic.

Meanwhile, the graphite materials obtained using the manufacturing methods described in Comparative Examples 1 to 17 satisfied that Lc (112) was within 4.0 nm to 30 nm, but failed to satisfy the condition that a carbon-derived spectrum appeared in a range of 3200 gauss (G) to 3400 gauss (G) in electron spin resonance spectroscopy measured using an X band or the conditions that the relative signal intensity ratio (I_{4.8K}/I_{40K}) was within 1.5 to 3.0, or that the line width (ΔHpp) was within 20 gauss (G) to 40 gauss (G) (Table 2). In lithium ion secondary cells, for which the above graphite materials were used as the negative electrodes, the 90-days capacity retention rates were within approximately 60% to 72%, and were extremely low values compared to those in Examples 1 to 11 (Table 2). The cause of the decrease in the capacity maintenance rate is that the decomposition reaction of the electrolyte solution can be easily caused in the negative electrode, and it is considered that, since the leak current of the negative electrode increases, and the difference from the leak current of the positive electrode increases, the operational ranges of the capacities of the positive and negative electrodes change, and, consequently, the service life characteristic degrades.

From the above results, it can be said that, in order to obtain a lithium ion secondary cell that achieves a high storage characteristic with a 90-day capacity retention rate of 89% or more, as the properties of the graphite material used as the negative electrode, it is an essential condition to satisfy that Lc (112), which is the crystallite size in a c-axis direction calculated from a (112) diffraction line measured using powder X-ray diffraction method, be within 4.0 nm to 30 nm, a carbon-derived spectrum appearing in electron spin resonance spectroscopy, which is measured using an X band, be in a range of 3200 gauss (G) to 3400 gauss (G), I_{4.8K}/I_{40K}, which is the relative signal intensity ratio of I_{4.8K}, which is the signal intensity of the spectrum measured at a temperature of 4.8 K, to I_{40K}, which is the signal intensity of the spectrum measured at a temperature of 40 K, be within 1.5 to 3.0, and ΔHpp, which is the line width of the spectrum measured from the primary derivative spectrum of the temperature of 4.8 K, be within 20 gauss (G) to 40 gauss (G).

From the above results, it can be said that, in order to obtain a lithium ion secondary cell that achieves a high storage characteristic, as the properties of the graphite material used as the negative electrode, it is an essential condition to satisfy that Lc (112) is within 4.0 nm to 30 nm, a carbon-derived spectrum appears in a range of 3200 gauss (G) to 3400 gauss (G) in electron spin resonance spectroscopy, the relative signal intensity ratio (I_{4.8K}/I_{40K}) is within 1.5 to 3.0, and the line width (ΔHpp) is in a range of 20 gauss (G) to 40 gauss (G).

The properties of the base oil compositions used in the manufacturing methods described in Examples 1 to 11 satisfy that the normal paraffin content is within 5 wt % to 20 wt %, and the aromatic index fa is in a range of 0.3 to 0.65. It was found that, when the above base oil composition is coked, and the powder of raw coke obtained by pulverizing and classifying the obtained raw coke (A, B, C, F, G, H, K, L and M) is carburized and then graphitized, or calcined coke obtained by calcining raw coke at 1400° C. is pulverized, classified, and then graphitized, the 90-days capacity retention rate of a cell, for which the obtained graphite material is used as the negative electrode, becomes 89% or more (Table 2), and it is possible to realize a lithium ion secondary cell that is extremely excellent in terms of the service life characteristic.

Meanwhile, the properties of the base oil compositions used in the manufacturing methods described in Comparative Examples 1 to 17 failed to satisfy either or both of the condition that the normal paraffin content is within 5 wt % to 20 wt %, and the condition that the aromatic index fa is in a range of 0.3 to 0.65. In a lithium ion secondary cell, for which the graphite material obtained by coking the above base oil composition, and pulverizing, classifying, carburizing and then graphitizing the obtained raw coke is used, since the decomposition reaction of the electrolyte solution is easily caused in the negative electrode, the operational ranges of the positive and negative electrodes easily change. In addition, since a film formed by the decomposition reaction product is likely to be formed on the edge surface of the negative electrode, and the resistance component of the reversible intercalation reaction of Li ions increases, the internal resistance of the cell increases, and the service life characteristic degrades, which is not desirable.

From the above results, it can be said that, as the properties of the base oil composition when manufacturing a graphite material, which is used as the negative electrode of a lithium ion secondary cell, it is an essential condition to satisfy that the normal paraffin content is within 5.0 wt % to 20 wt %, and the aromatic index fa is in a range of 0.3 to 0.65 in order to obtain a lithium ion secondary cell that achieves a high storage characteristic with a 90-days capacity retention rate of 89% or more.

### INDUSTRIAL APPLICABILITY

A lithium ion secondary cell, for which the graphite material of the invention is used, enables the securement of a high storage characteristic compared to a lithium ion secondary cell, for which a graphite material of the related art is used, and is thus available for industrial use, such as in vehicles, specifically, hybrid cars, plug-in hybrid cars and electrical cars, and in power storage in system infrastructure.

It should be noted that the entire contents of Japanese Patent Application No. 2010-277230 filed on Dec. 13, 2010, from which Convention priority is claimed is incorporated herein by reference.

It should also be understood that many modifications and variations of the described embodiments of the invention will be obvious to one of ordinary skill in the art without departing from the spirit and scope of the present invention as claimed in the appended claims.

What is claimed is:

1. A graphite material for a negative electrode of a lithium ion secondary cell,
wherein Lc (112), which is a crystallite size in a c-axis direction calculated from a (112) diffraction line measured using powder X-ray diffraction method, is within 4.0 nm to 30 nm,
a carbon-derived spectrum appearing in electron spin resonance spectroscopy, which is measured using an X band, is in a range of 3200 gauss (G) to 3400 gauss (G),
a relative signal intensity ratio I_{4.8K}/I_{40K} of I_{4.8K}, which is a signal intensity of the spectrum measured at a temperature of 4.8 K, to I_{40K}, which is a signal intensity of the spectrum measured at a temperature of 40 K, is within 1.5 to 3.0, and
ΔHpp, which is a line width of the spectrum calculated from a primary derivative spectrum of the temperature of 4.8 K, is within 20 gauss (G) to 40 gauss (G).

2. A method of manufacturing the graphite material for a negative electrode of a lithium ion secondary cell according to claim 1, comprising at least:
a step of coking a base oil composition having a normal paraffin content of 5.0 wt % to 20 wt % and an aromatic index fa, which is obtained using a Knight method, of 0.3 to 0.65 using a direct coking process; and
a step of a thermal process after the coking.

3. A lithium ion secondary cell comprising:
a negative electrode, for which the graphite material according to claim 1 is used.

4. The lithium ion secondary cell according to claim 3, further comprising:
a positive electrode including lithium which can be reversibly intercalated; and
a non-aqueous electrolyte.
